(19) United States
(12) Patent Application Publication
(10) Pub. No.: US 2024/0203078 A1
(43) Pub. Date: Jun. 20, 2024

(54) METHODS AND SYSTEMS FOR REFINING A 3D REPRESENTATION OF A SUBJECT

(71) Applicant: Verizon Patent and Licensing Inc., Basking Ridge, NJ (US)

(72) Inventors: Solmaz Hajmohammadi, San Francisco, CA (US); Richard A. Paris, Nashville, TN (US); Daniel M. Michler, Lexington, KY (US); Jie Yu, Natick, MA (US)

(21) Appl. No.: 18/083,940

(22) Filed: Dec. 19, 2022

(51) Int. Cl. G06T 19/20; G06T 7/55; G06T 7/90; G06T 15/04; G06T 17/20

(52) U.S. Cl. CPC G06T 19/20; G06T 7/55; G06T 7/90; G06T 15/04; G06T 17/20; G06T 2207/10028; G06T 2207/30168; G06T 2207/30196; G06T 2207/30221; G06T 2210/36; G06T 2219/2004

(57) ABSTRACT

An illustrative volumetric modeling system may obtain a provisional 3D representation of a subject present at a scene and identify a deficiency in the provisional 3D representation. The provisional 3D representation may be based on image data captured by a set of cameras configured to have different fields of view at the scene. The volumetric modeling system may determine a set of parameters for a parameterizable body model associated with a body type of the subject such that an application of the determined set of parameters to the body model may result in a parameterized body model that imitates a pose of the provisional 3D representation of the subject. Based on the provisional 3D representation and the parameterized body model, the volumetric modeling system may then generate a refined 3D representation of the subject in which the deficiency is mitigated. Corresponding methods and systems are also disclosed.

### BACKGROUND INFORMATION

Various types of image capture devices (referred to herein as cameras) are used to capture color and/or depth information representing subjects and objects at scenes being captured. For instance, a set of cameras (also referred to as a camera array) may be used to capture still and/or video images depicting the scene using color, depth, grayscale, and/or other image content. Such images may be presented to viewers and/or analyzed and processed for use in various applications.

As one example of such an application, three-dimensional (3D) representations of objects may be produced based on images captured by cameras with different poses (i.e., different positions and/or orientations so as to afford the cameras distinct vantage points) around the objects. As another example, computer vision may be performed to extract information about objects captured in the images and to implement autonomous processes based on this information. These and various other applications of image processing may be used in a variety of entertainment, educational, industrial, agricultural, medical, commercial, robotics, promotional, and/or other contexts and use cases. For instance, extended reality (e.g., virtual reality, augmented reality, etc.) use cases may make use of volumetric models generated based on intensity (e.g., color) and depth images depicting a scene from various vantage points (e.g., various perspectives, various locations, etc.) with respect to the scene.

In any of these types of applications, it would be desirable to capture complete and detailed image data for a subject as a 3D representation of the subject is constructed. Unfortunately, various circumstances and real-world conditions may make this ideal difficult to achieve. For instance, failure to capture a desired amount of information for a subject could occur as a result of no camera having a vantage point to see the subject (or a region of the subject), as a result of the subject (or a region of the subject) being occluded by another object at the scene, as a result of the subject being too far away from certain cameras to be captured with sufficient detail, or the like.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative volumetric modeling system for refining a 3D representation of a subject in accordance with principles described herein.

FIG. 2 shows an illustrative method for refining a 3D representation of a subject in accordance with principles described herein.

FIG. 3 shows an illustrative configuration in which a volumetric modeling system may operate to refine a 3D representation of a subject in accordance with principles described herein.

FIG. 4 shows an illustrative scene that includes a plurality of objects and is captured by a set of cameras in accordance with principles described herein.

FIG. 5 shows illustrative image data captured by a set of cameras for a subject, as well as illustrative aspects of how the image data may be used to generate and refine a 3D representation of the subject.

FIGS. 6-8 show several illustrative scenarios in which it may be desirable for a volumetric modeling system to refine a 3D representation of a subject to mitigate a deficiency in the 3D representation.

FIGS. 9-10 shows illustrative aspects of an example model-fitting technique that may be used to determine a set of parameters to fit a parameterizable body model to a pose of a subject.

FIG. 11 shows an illustrative computing device that may implement certain of the volumetric modeling systems and/or other computing systems and devices described herein.

### DETAILED DESCRIPTION OF EXAMPLE EMBODIMENTS

Methods and systems for refining a 3D representation of a subject are described herein. As mentioned above, various types of 3D representations (e.g., point cloud representations, volumetric mesh representations, voxelized representations, etc.) may be generated for a subject (e.g., a human or animal subject, etc.) and used in various types of applications and use cases, including by incorporating the 3D representations into an extended reality experience such as a virtual reality or augmented reality experience presented to a user. Unfortunately, as has also been mentioned, various circumstances may lead 3D representations of subjects to be produced with various types of deficiencies. For example, deficiencies may arise when particular regions of the subject cannot be suitably captured (e.g., captured at all or captured at a desired level of detail, etc.) at a certain moment in time as a result of circumstances such as, for instance, the subject being outside the fields of view of the cameras, being occluded by other objects, being too far away from the cameras to be captured with a desired pixel density, and so forth. Methods and systems described herein therefore relate to ways of detecting and mitigating such deficiencies. For example, based on methods and systems described herein, a volumetric modeling system may refine (e.g., enhance, supplement, enrich, improve, reconstruct, interpolate, etc.) a 3D representation detected to have certain deficiencies by supplementing captured data with data drawn from a parameterizable body model associated with the subject.

As one example, a human subject engaged in a sporting event (e.g., a football player playing in a football game) may be volumetrically modeled as the sporting event occurs (e.g., so as to provide users with a virtual reality experience that is associated with the sporting event and features a representation of the player). The volumetric modeling of this subject may be most effective when the subject is captured from various vantage points all around the subject. However, during the ordinary course of the game, it is likely that one or more other players may occlude parts of the subject from one or more of the vantage points of the cameras capturing the subject. If, for example, another player blocks the view of the subject's hand that a particular camera has for a particular frame, the 3D representation of the subject generated for that frame may lack information about the hand (at least from that angle) and may accordingly be incomplete or otherwise deficient. For instance, for the frame in question, the 3D representation of the subject may appear to not have a hand, or to have a distorted or poorly detailed representation of the hand as a result of the missing data.

To mitigate this, methods and systems described herein may utilize a parameterizable body model associated with the subject to help fill in missing data about the subject for whom sufficient capture data has not been able to be attained (e.g., details about the subject's hand in this particular example). For example, a domain-specific body model trained (e.g., using machine learning technologies, etc.) to take the form of a specific subject type (e.g., a human subject) may be parameterized and fitted to the subject so as to imitate the pose of the subject (including various physical characteristics of the subject such as his or her height, build, etc.). Once such a body model is parameterized and posed like the subject for the frame in question, a provisional 3D representation that has been constructed with the available capture data (i.e., the 3D representation in which the deficient hand data has been detected) may be refined (e.g., enhanced, supplemented, etc.) using corresponding data from the body model. For example, the hand from the body model could be used to stand in for a missing hand in the provisional 3D representation, the hand from the body model could be used to correct and improve a deformed hand in the provisional 3D representation, the hand from the body model could be used to enhance (e.g., increase the pixel density for) a poorly-detailed hand in the provisional 3D representation, or the like.

Various advantages and benefits may result from refined 3D representations (i.e., those produced based on both captured data and information from parameterized body models) being used instead of 3D representations limited only to whatever image data can be physically captured from a scene. For example, for capture scenarios involving large or complex capture areas, multiple highly-active subjects, and/or other such circumstances likely to introduce deficiencies into 3D representations being produced, volumetric modeling systems employing methods described herein may be capable of producing 3D representations that are more complete and detailed, and that have a higher degree of quality than could be produced based on captured data alone. Such improvements in 3D representations may make extended reality experiences more immersive and enjoyable for users and may similarly improve other types of applications and use cases in which volumetric modeling is performed and 3D representations of subjects are used.

Various specific implementations will now be described in detail with reference to the figures. It will be understood that the specific implementations described below are provided as non-limiting examples and may be applied in various situations. Additionally, it will be understood that other examples not explicitly described herein may also fall within the scope of the claims set forth below. Methods and systems for refining a 3D representation of a subject may provide any or all of the benefits mentioned above, as well as various additional and/or alternative benefits that will be described and/or made apparent below.

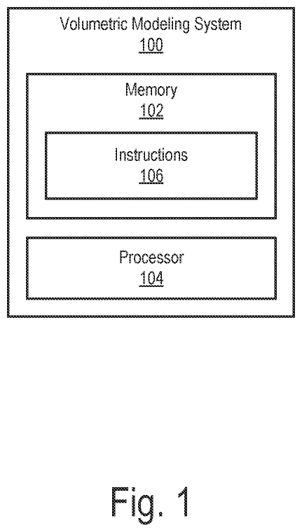

FIG. 1 shows an illustrative volumetric modeling system 100 for refining a 3D representation of a subject in accordance with principles described herein. System 100 may be implemented by computer resources such as processors, memory facilities, storage facilities, communication interfaces, and so forth. For example, system 100 may be implemented by multi-access edge compute (MEC) server systems operating on a provider network (e.g., a cellular data network or other carrier network, etc.), cloud compute server systems running containerized applications or other distributed software, on-premise server systems, user equipment devices, or other suitable computing systems as may serve a particular implementation.

System 100 may include memory resources configured to store instructions, as well as one or more processors communicatively coupled to the memory resources and configured to execute the instructions to perform functions described herein. For example, a generalized representation of system 100 is shown in FIG. 1 to include a memory 102 and a processor 104 selectively and communicatively coupled to one another. Memory 102 and processor 104 may each include or be implemented by computer hardware that is configured to store and/or execute computer software. Various other components of computer hardware and/or software not explicitly shown in FIG. 1 (e.g., networking and communication interfaces, etc.) may also be included within system 100. In some examples, memory 102 and processor 104 may be distributed between multiple devices and/or multiple locations as may serve a particular implementation.

Memory 102 may store and/or otherwise maintain executable data used by processor 104 to perform any of the functionality described herein. For example, memory 102 may store instructions 106 that may be executed by processor 104. Memory 102 may be implemented by one or more memory or storage devices, including any memory or storage devices described herein, that are configured to store data in a transitory or non-transitory manner. Instructions 106 may be executed by processor 104 to cause system 100 to perform any of the functionality described herein. Instructions 106 may be implemented by any suitable application, software, script, code, and/or other executable data instance. Additionally, memory 102 may also maintain any other data accessed, managed, used, and/or transmitted by processor 104 in a particular implementation.

Processor 104 may be implemented by one or more computer processing devices, including general-purpose processors (e.g., central processing units (CPUs), graphics processing units (GPUs), microprocessors, etc.), special-purpose processors (e.g., application-specific integrated circuits (ASICs), field-programmable gate arrays (FPGAs), etc.), or the like. Using processor 104 (e.g., when processor 104 is directed to perform operations represented by instructions 106 stored in memory 102), system 100 may perform functions associated with refining a 3D representation of a subject in accordance with methods and systems described herein and/or as may serve a particular implementation.

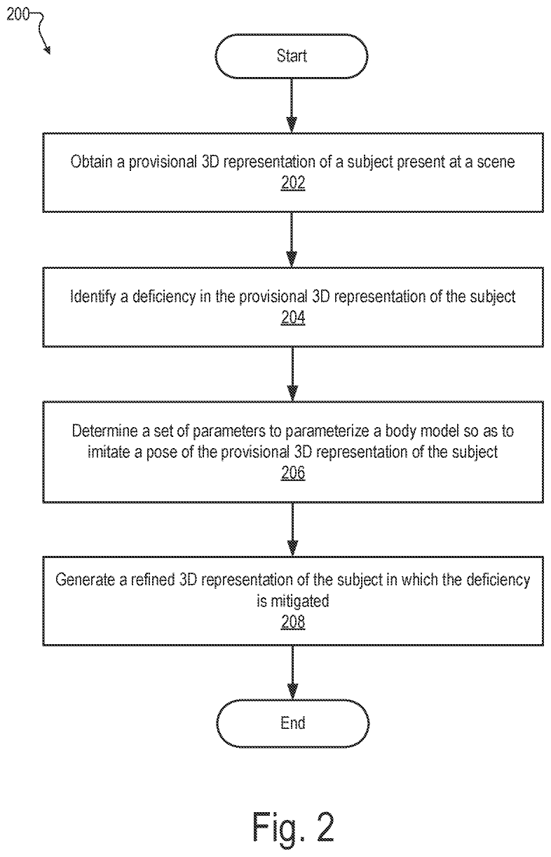

As one example of functionality that processor 104 may perform, FIG. 2 shows an illustrative method 200 for refining a 3D representation of a subject in accordance with principles described herein. While FIG. 2 shows illustrative operations according to one implementation, other implementations may omit, add to, reorder, and/or modify any of the operations shown in FIG. 2. In some examples, multiple operations shown in FIG. 2 or described in relation to FIG. 2 may be performed concurrently (e.g., in parallel) with one another, rather than being performed sequentially as illustrated and/or described. One or more of the operations shown in FIG. 2 may be performed by a volumetric modeling system such as system 100 and/or any implementation thereof.

In certain examples, operations of method 200 may be performed in real time so as to provide, receive, process, and/or use data described herein immediately as the data is generated, updated, changed, exchanged, or otherwise becomes available (e.g., analyzing captured image data, producing refined 3D representations based on the image data, providing volumetric content incorporating the refined 3D representations, etc., even as the subjects represented within the image data are engaged in the behaviors depicted in the volumetric content). In such examples, certain operations described herein may involve real-time data, real-time representations, real-time conditions, and/or other real-time circumstances. As used herein, “real time” will be understood to relate to data processing and/or other actions that are performed immediately, as well as conditions and/or circumstances that are accounted for as they exist in the moment when the processing or other actions are performed. For example, a real-time operation may refer to an operation that is performed immediately and without undue delay, even if it is not possible for there to be absolutely zero delay. Similarly, real-time data, real-time representations, real-time conditions, and so forth, will be understood to refer to data, representations, and conditions that relate to a present moment in time or a moment in time when decisions are being made and operations are being performed (e.g., even if after a short delay), such that the data, representations, conditions, and so forth are temporally relevant to the decisions being made and/or the operations being performed.

Each of operations 202-208 of method 200 will now be described in more detail as the operations may be performed by an implementation of system 100 (e.g., by processor 104 executing instructions 106 stored in memory 102).

At operation 202, system 100 may obtain a provisional 3D representation of a subject present at a scene. As used herein, a 3D representation of a subject may refer to any suitable volumetric or other three-dimensional representation, model, depiction, etc., of any suitable subject (e.g., human or animal subject, inanimate object, etc.). For instance, a 3D representation may be implemented as a point cloud representation, a mesh representation (with or without a texture applied to the mesh), a voxelized representation, or any other suitable data structure configured to represent the subject in any manner as may serve a particular implementation. As used herein, a 3D representation may be referred to as a “provisional” 3D representation when it has not yet been refined in accordance with methods and principles described herein, or at least when there is further refinement to be performed before the 3D representation will be considered to be fully-refined and presentable. For example, a provisional 3D representation may be implemented as a point cloud or mesh representation of a subject that has been constructed exclusively from captured image data and that does not yet incorporate any information from a body model or other auxiliary source of information (as will be described in more detail below). In contrast, as will be further described below, “refined” 3D representations, as that term is used herein, will be understood to refer to 3D representations that have been refined in accordance with methods and/or principles described herein so as to incorporate not only captured image data but also auxiliary data such as information derived from a particular body model or other machine learning model.

The provisional 3D representation obtained at operation 202 may be based on (e.g., exclusively based on) image data captured by a set of cameras configured to have different fields of view according to different vantage points the cameras have at the scene. For example, if the subject is a human subject (e.g., a football player) present in a scene of a sports venue (e.g., on a football field), the set of cameras may be disposed at various locations around the scene (e.g., around the football field) and may be inwardly facing so as to capture the human subject and other subjects and/or objects present at the scene from a variety of vantage points. A sports venue scene with a human subject involved in a sporting event will be illustrated and described in more detail below.

In some implementations, system 100 may obtain the provisional 3D representation at operation 202 by receiving the provisional 3D representation from an associated system that is configured to analyze the image data from the cameras and to generate the provisional 3D representation based on that image data. In other implementations, system 100 may obtain the provisional 3D representation at operation 202 by generating the provisional 3D representation itself, based on the image data captured by the set of cameras. For example, the image data captured by the set of cameras may include both color data and depth data representative of objects present at the scene (captured by respective color and depth capture devices at the scene) and the obtaining of the provisional 3D representation of the subject may be performed by generating the provisional 3D representation of the subject based on color data and depth data representative of the subject. In some examples, system 100 may capture the image data itself (e.g., if the set of cameras are incorporated into system 100) or may receive captured image data from an external set of cameras (e.g., if the cameras are not incorporated into system 100) and use the captured image data to construct the provisional 3D representation. In some examples, this may be performed on a frame-by-frame basis as the subject moves through the scene and the set of cameras (which may be synchronized with one another in certain implementations) captures respective sequences of images depicting the subject from the respective vantage points of the cameras. When such frame-by-frame modeling is performed, individual 3D representations associated with discrete moments in time (e.g., associated with different frame times) may be sequenced to create a time-varying 3D representation (also referred to as a 4D representation with the fourth dimension being a time dimension) of the subject that moves and imitates behaviors of the subject (e.g., a football player running down the field, etc.).

At operation 204, system 100 may identify a deficiency in the provisional 3D representation of the subject that was obtained at operation 202. For example, as a provisional representation constructed exclusively from image data that has been captured at the scene, the obtained 3D representation may be limited in scope and quality by the image data that is available (i.e., that was able to be captured under whatever circumstances happen to presently exist at the scene). Such limits may lead to deficiencies associated with missing regions of the subject (e.g., for which no data is available), distorted regions of the subject (e.g., for which the data is suspect, incorrect, or incomplete), undetailed regions of the subject (e.g., for which the level of detail is lower than may be desired, etc.), or the like. As one example, if the subject happens to be far away from certain cameras in the set of cameras (e.g., on the opposite side of a large playing field), the deficiency identified at operation 204 may be associated with a relatively low pixel density of certain image data representing certain regions of the subject (i.e., depicting these regions with insufficient detail). As another example, if parts of the subject happen to be occluded from certain camera views (e.g., a player that is partially occluded by the presence of other players in the vicinity), the deficiency identified at operation 204 may be associated with missing data that could not be captured for the subject as a result of the occlusion.

At operation 206, system 100 may determine a set of parameters for a body model. The body model may be parameterizable to adaptively model (e.g., imitate the form of) a body type of the subject (e.g., a human body or another suitable body type for another type of subject such as an animal or particular type of inanimate object). As such, the determining of the set of parameters performed at operation 206 may be performed such that an application of the set of parameters to the body model will result in a parameterized body model that imitates a pose of the provisional 3D representation of the subject. For example, as will be described an illustrated in an extended example below, if the subject is a football player running down a football field, the set of parameters may be determined such that a human body model will imitate (e.g., approximately take the form of) the football player, including taking on an approximate height and build of the particular player, being posed with the same particular running posture the player has, and so forth.

In some implementations, the identifying of the deficiency at operation 204 and the determining of the set of parameters at operation 206 may be performed independently from one another, either concurrently or in an arbitrary sequence (e.g., with operation 204 performed prior to operation 206 as shown in FIG. 2 or with operation 206 performed prior to operation 204). In other implementations, one or more dependencies may exist between these operations such that one is performed based on an outcome of the other.

For example, in a particular implementation, the determining of the set of parameters for the body model (at operation 206) may specifically be performed prior to the identifying of the deficiency in the provisional 3D representation of the subject (at operation 204). Moreover, in this example, an additional operation (not explicitly shown in FIG. 2) may also be performed subsequent to the application of the set of parameters to the body model. Specifically, as will be described in more detail below, system 100 may apply texture content to the parameterized body model (after the set of parameters determined at operation 206 has been applied to make the body model imitate the provisional 3D representation), where the texture content is based on the image data captured by the set of cameras. In this implementation, the identifying of the deficiency in the provisional 3D representation (at operation 204) may therefore be performed based on an analysis of the parameterized body model to which the texture content has been applied. For instance, after parameterizing the body model to imitate the provisional 3D representation and applying whatever texture content happens to be available (i.e., whatever image data has been captured by the cameras given the current condition of the scene in terms of where the cameras are positioned, where the subjects are positioned, which objects may occlude other objects from certain perspectives, etc.), system 100 may be configured to identify any regions of the textured and parameterized body model that lack sufficient texture content and/or detail according to any standard as may serve a particular implementation. Such regions may be informally referred to (or thought of) as “holes” that can be “filled in” using the body model. For instance, if only a few points have been captured for a subject's nose, the sparse texture content applied to the nose of the parameterized body model at this stage may be associated with a deficiency (i.e., a “hole”) that is to be addressed in the revising of the provisional 3D representation. For example, the nose of the parameterized body model may provide a useful approximation of a nose with which to fill in the deficiently captured nose of the actual subject and the refining of the provisional 3D representation may rely on data from the body model that is associated with the body model's nose.

At operation 208, system 100 may generate a refined 3D representation of the subject in which the deficiency identified at operation 204 is mitigated. As has been mentioned (and as will be described and illustrated in more detail below), this refined 3D representation may be generated based on both the provisional 3D representation obtained at operation 202 and the parameterized body model parameterized at operation 206. In this way, the deficiency identified at operation 204 may be eliminated or otherwise mitigated from the final 3D representation that will be used (e.g., incorporated into volumetric content, presented to a user, or otherwise employed in the relevant application or use case). For instance, the nose-related example described above provides one example of filling in an identified “hole” in the model. As another example, if a hand of a subject is represented with missing data or distortion in an otherwise suitable provisional 3D representation, the refined 3D representation generated at operation 208 may involve incorporating hand-related data from the parameterized body model (for which the set of parameters were determined at operation 206) into the provisional 3D representation to mitigate this hand-related deficiency and produce a refined 3D representation of the subject in which the hand (as well as every other part subject) is complete, accurate, and sufficiently detailed.

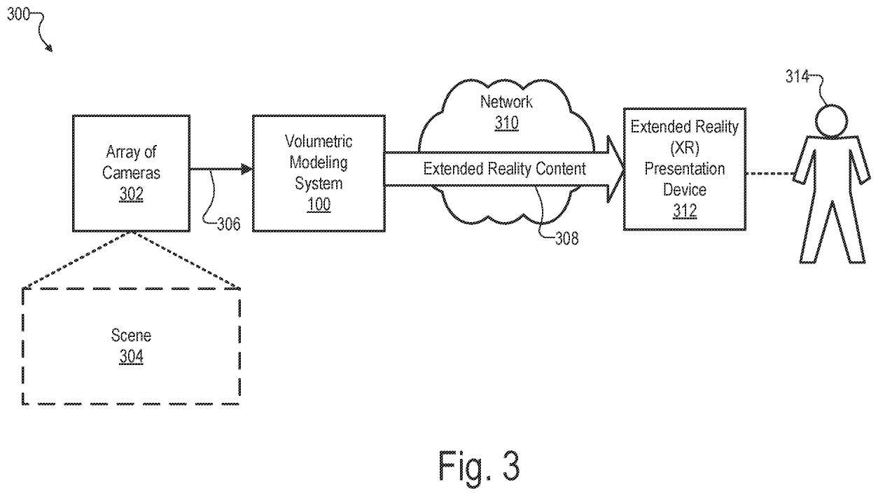

FIG. 3 shows an illustrative configuration 300 in which a volumetric modeling system may operate to refine a 3D representation of a subject in accordance with principles described herein. As shown, FIG. 3 includes an implementation of volumetric modeling system 100, which may operate as described above in relation to FIGS. 1 and 2 and in accordance with additional principles described below. Additionally, configuration 300 explicitly shows an array of cameras 302, which will be understood to include a set of cameras (not individually shown in FIG. 3) configured to capture imagery from various vantage points at a scene 304. Image data 306 is shown to be produced by the array of cameras 302 and to be provided to system 100 for the purpose of modeling (e.g., generating 3D representations of) various objects (including human and animal subjects, inanimate objects, etc.) in scene 304. Image data 306 may represent a plurality of images captured by the various cameras 302 of the array from various poses in which the cameras have been arranged and calibrated at scene 304. System 100 may generate 3D representations of objects in the scene based on the images represented in image data 306, body models associated with the objects (not explicitly shown in FIG. 3), calibration parameters received from a camera calibration system (not explicitly shown in FIG. 3), and/or other suitable information. Based on the analysis and processing of these various types of information (including images represented in image data 306) system 100 may generate extended reality content 308, which may be provided by way of a network 310 to an XR presentation device 312 used by a user 314 to engage in an extended reality experience based on the extended reality content.

While configuration 300 represents one particular use case or application of a volumetric modeling system such as system 100 (i.e., a specific extended reality use case in which image data 306 representing objects in scene 304 is used to generate volumetric representations of the objects for use in presenting an extended reality experience to user 314), it will be understood that system 100 may similarly be used in various other use cases and/or applications as may serve a particular implementation. For example, implementations of system 100 may be used to perform volumetric modeling (including by refining 3D representations of certain types of subjects) for use cases that do not involve extended reality content but rather are aimed at more general computer vision applications, object modeling applications, or the like. Indeed, system 100 may be employed for any suitable image processing application or use case in fields such as entertainment, education, manufacturing, medical imaging, robotic automation, or any other suitable field. Thus, while configuration 300 and various examples described and illustrated herein use volumetric object modeling and extended reality content production as an example use case, it will be understood that configuration 300 may be modified or customized in various ways to suit any of these other types of applications or use cases. Each of the elements of configuration 300 will now be described in more detail.

The array of cameras 302 (also referred to herein as image capture devices) may be configured to capture image data (e.g., color data, intensity data, depth data, and/or other suitable types of image data) associated with scene 304 and objects included therein (i.e., objects present at the scene). For instance, the array of cameras 302 may include a synchronized set of video cameras that are each oriented toward the scene and configured to capture color images depicting objects at the scene. Additionally, the same video cameras (or distinct depth capture devices associated with the video cameras) may be used to capture depth images of the objects at the scene using any suitable depth detection techniques (e.g., stereoscopic techniques, time-of-flight techniques, structured light techniques, etc.). As will be illustrated in more detail below, each of cameras 302 included in the array may have a different pose (i.e., position and orientation) with respect to the scene being captured (i.e., scene 304 in this example). The poses of the cameras may be selected, for example, to provide coverage of the scene, or at least of a particular volumetric capture zone defined at the scene (not explicitly shown in FIG. 3), from various perspectives around the scene so that each object at the scene (including human subjects, animal subjects, inanimate objects, etc.) may be volumetrically modeled in ways described below. For instance, in one example, cameras 302 could be arranged in a circle around scene 304 and could be oriented to face inward toward a center of that circle, while in other examples, the cameras could be arranged in other suitable shapes and configurations.

Scene 304 may represent any real-world area for which image data is captured by the array of cameras 302. Scene 304 may be any suitable size from a small indoor studio space to a large outdoor field or larger space, depending on the arrangement and number of cameras 302 included in the array. Certain scenes 304 may include or otherwise be associated with a particular volumetric capture zone that is defined with an explicit boundary to guarantee a minimum level of coverage by the array of cameras 302 (e.g., coverage from multiple perspectives around the zone) that may not necessarily be provided outside of the zone. For example, for a scene 304 at a sports stadium, the volumetric capture zone may be limited to the playing field on which the sporting event takes place.

Scene 304 may include one or more objects (not explicitly shown in FIG. 3) that are of interest in the application and that are to be volumetrically modeled (e.g., for presentation in an extended reality experience or the like). For instance, scene 304 may include a set of human subjects that are to be volumetrically modeled for presentation as part of extended reality content 308. In one example, scene 304 could include a playing field where a sporting event is taking place and being captured by a mutually-calibrated set of cameras. In this example, the objects of interest within scene 304 could include a set of players engaged in the sporting event on the playing field, as well as referees, a ball and/or other such objects associated with the game, and so forth. In other examples, scene 304 could be implemented in other ways, such as by including a stage where a concert or theatrical performance is taking place, a set for a film or television show where actors are performing, or the like. In any of these examples, respective 3D representations of various objects within scene 304 may be generated and provided as part of an extended reality content stream or in another suitable manner.

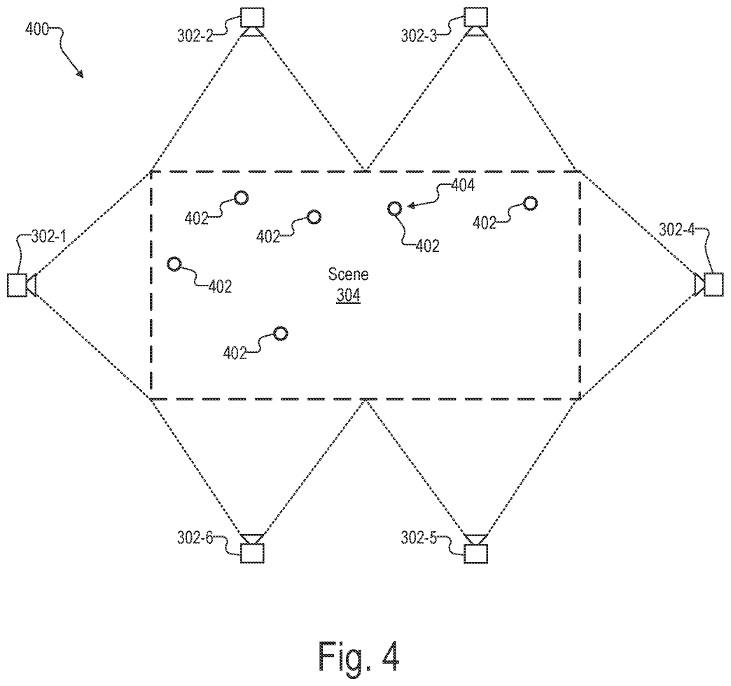

To illustrate an example of how the array of cameras 302 may be posed with respect to scene 304 and the objects included therein, FIG. 4 shows an illustrative implementation 400 of scene 304 that includes a plurality of objects 402 and this is shown to be captured by an array of six cameras 302 labeled as cameras 302-1 through 302-6. As shown, implementation 400 of scene 304 is depicted from a top view and is associated with a volumetric capture area demarcated by a dashed line in FIG. 4. As mentioned above and as indicated by dotted lines representing the respective fields of view of each camera 302, objects located within the dashed line of the volumetric capture area should normally be captured from various angles by several of cameras 302 (barring another object occluding the view, etc.). In this example, scene 304 is shown to be a rectangular scene surrounded by a set of six cameras 302. Collectively, these cameras 302 may be arranged to capture scene 304 (or at least the volumetric capture area at the scene) from various angles and perspectives, such that information about many sides of any object 402 present within scene 304 can be effectively captured.

Returning to FIG. 3, image data 306 may represent imagery that is captured by the array of cameras 302 and that depicts scene 304 (and objects 402 included therein) from the various perspectives afforded by the vantage points of the various cameras. For example, the objects 402 represented by image data 306 may be objects of interest for volumetric modeling, such as human subjects (e.g., players in a sporting event in one example), animal subjects, or other objects. As will be described and illustrated in more detail below, image data 306 captured for these objects 402 may take the form of images (e.g., sequences of video frames in certain examples) that depict the objects 402 in various ways. For instance, color or intensity images may use color data to depict how light naturally interacts with the objects (e.g., what the objects look like, their colors and textures, etc.), while corresponding depth images for the objects 402 may depict the physical depth and/or other geometric attributes of various surface points of the objects (using grayscale or other depth data). For example, depth data in such depth images may indicate where various surface points are located with respect to the cameras capturing the depth data. Image data 306 will be understood to include, at least in certain implementations, corresponding color/intensity data and depth data in the form of corresponding color images and depth images.

The implementation of volumetric modeling system 100 shown to be receiving image data 306 in FIG. 3 may be implemented within any suitable computing system (e.g., a MEC server, a cloud server, an on-premise server, a user equipment device, etc.) that is configured to generate extended reality content 308 based on image data 306 captured by the array of cameras 302. Along with image data 306, system 100 may also rely on other data to generate extended reality content 308. As one example that will be described and illustrated in more detail below, system 100 may access a parameterizable body model that may be used to remedy or otherwise mitigate deficiencies (e.g., fill in holes) that are identified in a provisional 3D representation that is generated only based on image data 306. As another example, system 100 may access calibration parameters that may be used in the effective and efficient production of volumetric content representative of scene 304. For example, volumetric content (e.g., provisional 3D representations of subjects present in scene 304) may be produced by processing, in accordance with such calibration parameters, an image set obtained from the array of cameras 302. Volumetric content (e.g., refined 3D representations of subjects) produced by system 100 in this way may be integrated with extended reality content 308 that is then provided to XR presentation device 312 by way of network 310.

Extended reality content 308 may be represented by a data stream generated by system 100 that includes volumetric content (e.g., refined 3D representations of objects at scene 304, etc.) and/or other data (e.g., metadata, etc.) useful for presenting the extended reality content. As shown, a data stream encoding extended reality content 308 may be transmitted by way of network 310 to XR presentation device 312 so that extended reality content 308 may be presented by the device to user 314. Extended reality content 308 may include any number of volumetric representations of objects 402 (including subject 404) and/or other such content that, when presented by XR presentation device 312, provides user 314 with an extended reality experience involving the volumetric object representations. For instance, in the example in which scene 304 includes a playing field where a sporting event is taking place and the objects 402 represented volumetrically in extended reality content 308 are players involved in the sporting event, the extended reality experience presented to user 314 may allow user 314 to immerse himself or herself in the sporting event such as by virtually standing on the playing field, watching the players engage in the event from a virtual perspective of the user's choice (e.g., right in the middle of the action, etc.), and so forth.

Network 310 may serve as a data delivery medium by way of which data may be exchanged between a server domain (in which system 100 is included) and a client domain (in which XR presentation device 312 is included). For example, network 310 may be implemented by any suitable private or public networks (e.g., a provider-specific wired or wireless communications network such as a cellular carrier network operated by a mobile carrier entity, a local area network (LAN), a wide area network, the Internet, etc.) and may use any communication technologies, devices, media, protocols, or the like, as may serve a particular implementation.

XR presentation device 312 may be configured to provide an extended reality experience to user 314 and to present refined 3D representations (e.g., refined 3D representations incorporated into extended reality content 308) to user 314 as part of the extended reality experience. To this end, XR presentation device 312 may represent any device used by user 314 to view volumetric representations (e.g., including refined 3D representations) of objects 402 that are generated by system 100 and are included within extended reality content 308 received by way of network 310. For instance, in certain examples, XR presentation device 312 may include or be implemented by a head-mounted extended reality device that presents a fully-immersive virtual reality world, or that presents an augmented reality world based on the actual environment in which user 314 is located (but adding additional augmentations such as volumetric object representations produced and provided by system 100). In other examples, XR presentation device 312 may include or be implemented by a mobile device (e.g., a smartphone, a tablet device, etc.) or another type of media player device such as a computer, a television, or the like.

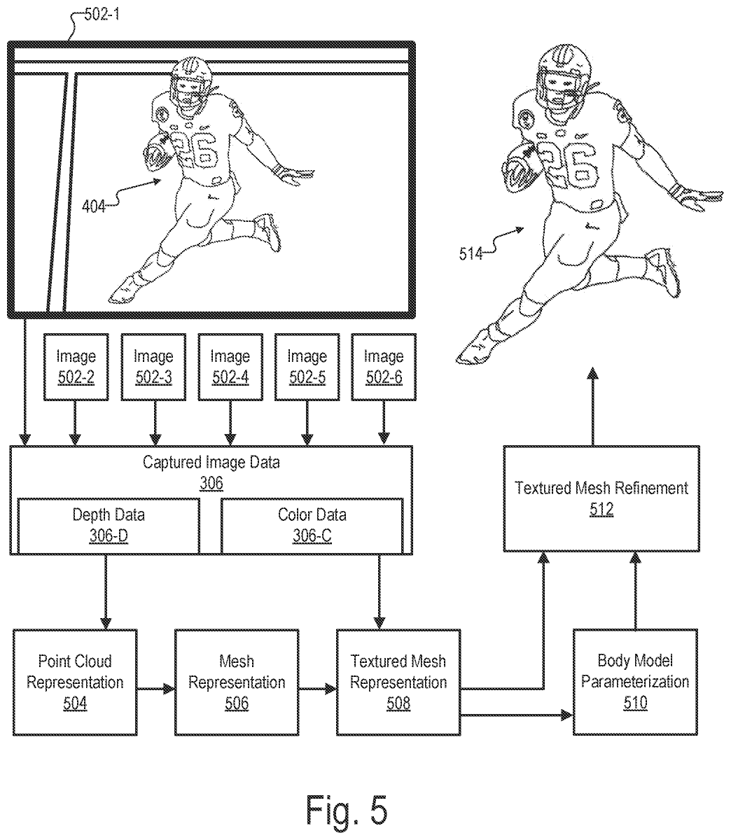

FIG. 5 shows illustrative aspects of image data captured by a set of cameras for a subject, as well as illustrative aspects of how that image data may be used to generate and refine a 3D representation of the subject. More particularly, FIG. 5 shows how images captured by various cameras 302 (e.g., cameras 302 illustrated in FIG. 4 to be capturing scene 304) may depict a subject 404 (a particular one of objects 402, as indicated by a reference label in FIG. 4) from a plurality of different perspectives so as to serve as a basis of a provisional 3D representation of the subject and, when processed in combination with other data described herein, to ultimately serve as a basis for a refined 3D representation of the subject.

In the example of FIG. 5, subject 404 is shown to be a football player running on a playing field that will be understood to part of scene 304. Subject 404 is depicted from one perspective in an image 502-1 that will be understood to have been captured by camera 302-1. While other images 502-2 through 502-6 (collectively referred to herein as images 502) are not explicitly shown in the same manner as image 502-1 in FIG. 5, it will be understood that these images 502 similarly depict subject 404 from the respective vantage points of the other cameras 302 at scene 304 (e.g., image 502-2 depicting subject 404 from the vantage point of camera 302-2, image 502-3 depicting subject 404 from the vantage point of camera 302-3, etc.). As shown in FIG. 5, captured image data 306 (described above) may incorporate data representing each of these images 502 and may include both depth data (labeled as depth data 306-D) and color data (labeled as color data 306-C). For example, each image 502 may include both a color image (explicitly represented by the line drawing of the football player in FIG. 5) and a depth image (not explicitly shown in FIG. 5).

Based on the different types of captured image data 306 (i.e., based on depth data 306-D and color data 306-C), FIG. 5 shows how various 3D representations of the subject 404 may be generated and refined in accordance with methods and processes described herein (e.g., including method 200 described above). For example, for a subject 404 that is human subject present at the scene (as shown), FIG. 5 shows that a point cloud representation 504 of the human subject may be generated based on the depth data 306-D. Point cloud representation 504 may be used to form a mesh representation 506 of subject 404, which may then be textured using the color data 306-C to form a textured mesh representation 508 of the human subject 404. Each of these representations 504-508 may be considered to be provisional 3D representations of subject 404 and any or all of them may serve as the provisional 3D representation that that is refined in accordance with principles described herein. In the particular example of FIG. 5, textured mesh representation 508 is shown to be refined using a body model parameterization 510 and by way of a textured mesh refinement 512. In this way, a refined 3D representation 514 is produced as a textured mesh representation with the same appearance as the human subject 404. To illustrate the likeness of refined 3D representation 514 with subject 404, FIG. 5 shows refined 3D representation 514 from a perspective similar to the perspective of camera 302-1 when capturing image 502-1. Though not explicitly shown in FIG. 5, it will be understood that certain deficiencies present in the image data and provisional 3D representations of the subject (e.g., representations 504-508) may be mitigated within refined 3D representation 514 based on the parameterized body model.

A generalized embodiment of a volumetric modeling system configured to obtain and refine a 3D representation of a subject has been described in relation to FIG. 1, a generalized method for obtaining and refining a 3D representation of a subject has been described in relation to FIG. 2, an example configuration in which a volumetric modeling system may operate to perform such a method within a context of an extended reality application has been described in relation to FIGS. 3-4, and example image data has been described in relation to certain aspects of FIG. 5. Additional aspects and details associated with such volumetric modeling systems, methods, and configurations will now be described in relation to FIGS. 5-11, including by describing each of the elements of FIG. 5 that derive from and/or are used with captured image data 306.

Point cloud representation 504 is shown to be generated based on depth data 306-D (e.g., a plurality of synchronously captured depth data images that each depict subject 404 from different perspectives around the subject). Point cloud representation 504 may be generated based on depth data 306-D in any suitable way and may incorporate a plurality of points defined in relation to a coordinate system associated with scene 304. Because each of these points may correspond to depth data captured by at least one of cameras 302 in at least one of the depth images represented within captured image data 306, the plurality of points may collectively form a “cloud”-like object having the shape and form of subject 404 and located within the coordinate system at a location that corresponds to the location of subject 404 within scene 304.

Mesh representation 506 is shown to be generated based on point cloud representation 504. Like point cloud representation 504, mesh representation 506 may be based only on depth data 306-D, ultimately leading mesh representation 506 to be limited to describing the physical shape, geometry, and location of subject 404 (rather than describing, for example, the appearance and texture of the subject). However, whereas point cloud representation 504 may be implemented by a large number of surface points where surfaces of subject 404 have been detected in the space of scene 304, mesh representation 506 may represent the outer surface of subject 404 in a cleaner (e.g., better defined and less fuzzy) and more efficient (in terms of data economy) manner as a mesh of interconnected vertices. These interconnected vertices of mesh representation 506 may form a large number of geometric shapes (e.g., triangles, quadrilaterals, etc.) that collectively reproduce the basic shape and form of point cloud representation 504 and the actual subject 404 as depicted in images 502.

Textured mesh representation 508 is shown to be based on mesh representation 506 but also to account for color data 306-C. For example, at this stage of the process, texture content (e.g., color data representative of photographic imagery that has been captured) may be applied to mesh representation 506 in a manner analogous to overlaying a skin onto a wireframe object. When this texturing is complete, textured mesh representation 508 may be considered a full and complete 3D representation of volumetric model of subject 404 that would be suitable for inclusion in extended reality content 308 or another type of content associated with another suitable volumetric application. However, as has been mentioned, various circumstances (e.g., circumstances present at the scene itself and/or associated with the image capture setup or procedure being used) may lead captured image data 306, and hence also the textured mesh representation 508 derived therefrom, to have certain deficiencies that may be desirable to mitigate prior to the textured mesh representation being presented to a user (or otherwise used in the relevant application for which the volumetric modeling is being performed). A few examples of the types of circumstances that may lead to such deficiencies (and thereby make it useful to perform body model parameterization 510 and textured mesh refinement 512) will now be illustrated and described.

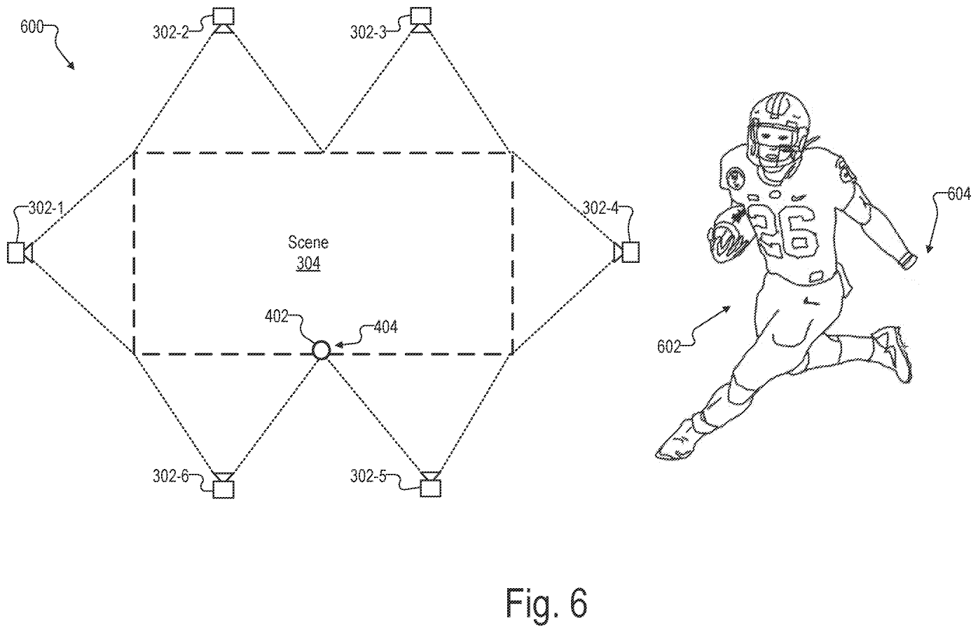

FIGS. 6-8 show several illustrative scenarios in which deficiencies in captured image data may be introduced and in which it may hence be desirable for volumetric modeling systems such as system 100 to refine provisional 3D representations of a subject (e.g., to refine textured mesh representation 508 of subject 404 to ultimately produce refined 3D representation 514). In each of FIGS. 6-8, a different scenario is illustrated with reference to cameras 302, scene 304, and one or more of objects 402 (including subject 404) as these elements have already been described (e.g., in relation to FIG. 4, etc.). Additionally, each of FIGS. 6-8 also show, adjacent to the scenario depicted by the cameras and the scene, a textured mesh representation (e.g., analogous to textured mesh representation 508 described above) featuring an illustrative deficiency that could arise from the particular scenario. Each of FIGS. 6-8 will now be described in more detail.

FIG. 6 shows an illustrative scenario 600 in which a deficiency in the provisional 3D representation of subject 404 may be identified at a region of the provisional 3D representation that corresponds to a region of subject 404 that is not located within any of the different fields of view of the set of cameras 302. For illustrative clarity, the only object 402 depicted to be present within scene 304 in scenario 600 is subject 404. In this example, subject 404 is shown to be very close to the boundary of a capture area associated with scene 304. This boundary is indicated with a dashed line in FIG. 6 and defined based on the respective fields of view of the set of cameras 302 (e.g., as indicated by the dotted lines extending from each camera 302). More particularly, as shown, subject 404 happens to be located immediately proximate to the outer edges of respective fields of view of both cameras 302-5 and 302-6.

Due to this position of subject 404, as well as the arrangement and configuration of the set of cameras 302, subject 404 will be understood to be located right on the fringe of what cameras 302-5 and 302-6 are able to capture. Indeed, given the position of subject 404 shown in FIG. 6, certain regions of subject 404 (e.g., protruding extremities such as a hand, etc.) may actually fall outside of the fields of view of these cameras or be located so close to the boundaries as to be captured in a distorted or other suboptimal way. Accordingly, a textured mesh representation 602 illustrated in FIG. 6 for subject 404 shows a deficiency 604 in which a left hand of subject 404 (e.g., a hand that may have been outside both fields of view of cameras 302-5 and 302-6 when the images were captured from which textured mesh representation 602 was derived) appears to be missing from the player's body. The missing hand of deficiency 604 will be understood to represent just one example manifestation of this type of framing-related deficiency. For example, since the hand region of subject 404 may be captured from other perspectives (e.g., of cameras 302-1 through 302-4), this deficiency could manifest itself as having a partial hand, a “hollowed-out” hand (with the surfaces of one side missing), or a hand that is otherwise distorted as a result of the missing information from cameras 302-5 and 302-6. As will be described in more detail below, deficiency 604 may represent one type of deficiency that may be remedied or otherwise mitigated by refining a provisional 3D representation (e.g., textured mesh representation 602) in accordance with principles described herein.

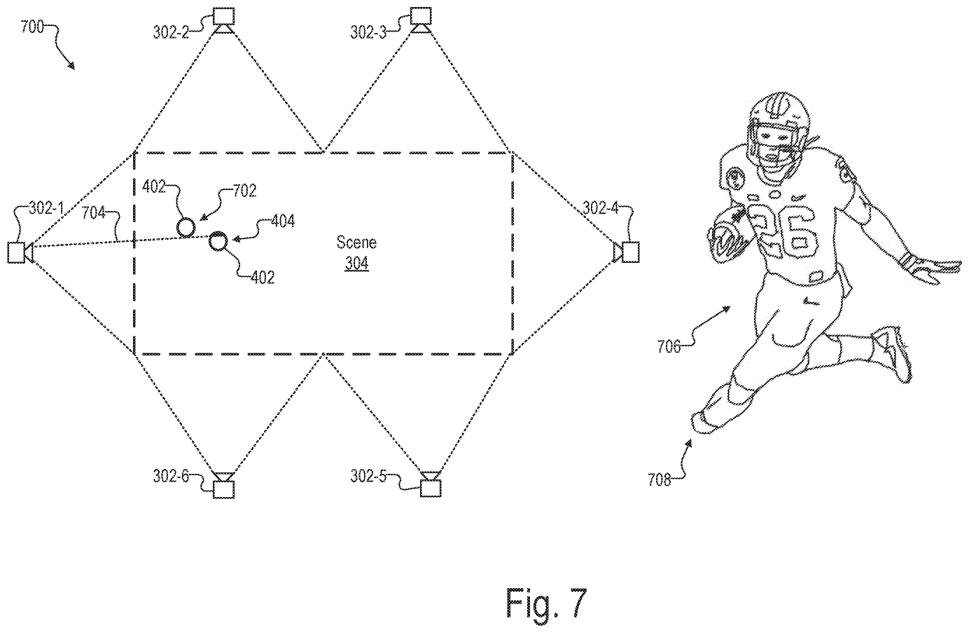

FIG. 7 shows an illustrative scenario 700 in which a deficiency in the provisional 3D representation of subject 404 may be identified at a region of the provisional 3D representation that corresponds to a region of subject 404 that is occluded, within a particular one of the different fields of view in which the region of subject 404 is located, by an object present at the scene and further located in the particular one of the different fields of view. For illustrative clarity, two objects 402 are depicted to be present within scene 304 in scenario 700: subject 404 and an occluding object 702 that is located within the field of view of camera 302-1 so as to occlude, from the viewpoint of camera 302-1, a shaded region of subject 404. In this example, an illustrative ray 704 is shown within the field of view of camera 302-1 to be drawn from camera 302-1 to tangentially intersect the edge of occluding object 702. As illustrated by ray 704, occluding object 702 occludes (from the view of camera 302-1) the shaded portion on the top of the circle representing subject 404.

Due to the geometry of camera 302-1, occluding object 702, and subject 404, a certain region of subject 404 will not be depicted in an image captured by camera 302-1 at this moment in time. For example, certain regions of subject 404 (e.g., protruding extremities such as a foot, etc.) may, from the perspective of camera 302-1, be positioned behind occluding object 702 (e.g., another player or another object on the field) so as to not be not captured at all or to be captured in a distorted or other suboptimal way. Accordingly, a textured mesh representation 706 illustrated in FIG. 7 for subject 404 shows a deficiency 708 in which a left foot of subject 404 (e.g., a foot that may have been occluded by occluding object 702 when a particular image was captured by camera 302-1 from which textured mesh representation 706 was derived) appears to be missing from the player's body. The missing foot of deficiency 708 will be understood to represent just one example manifestation of this type of occlusion-related deficiency. For example, since the foot region of subject 404 may be captured from other perspectives (e.g., of cameras 302-2, 302-4, and/or 302-6), this deficiency could manifest itself as having a partial foot, a “hollowed-out” foot (with the surfaces of certain sides missing), or a foot that is otherwise distorted as a result of the missing information from camera 302-1. As will be described in more detail below, deficiency 708 may represent another type of deficiency that may be remedied or otherwise mitigated by refining a provisional 3D representation (e.g., textured mesh representation 706) in accordance with principles described herein.

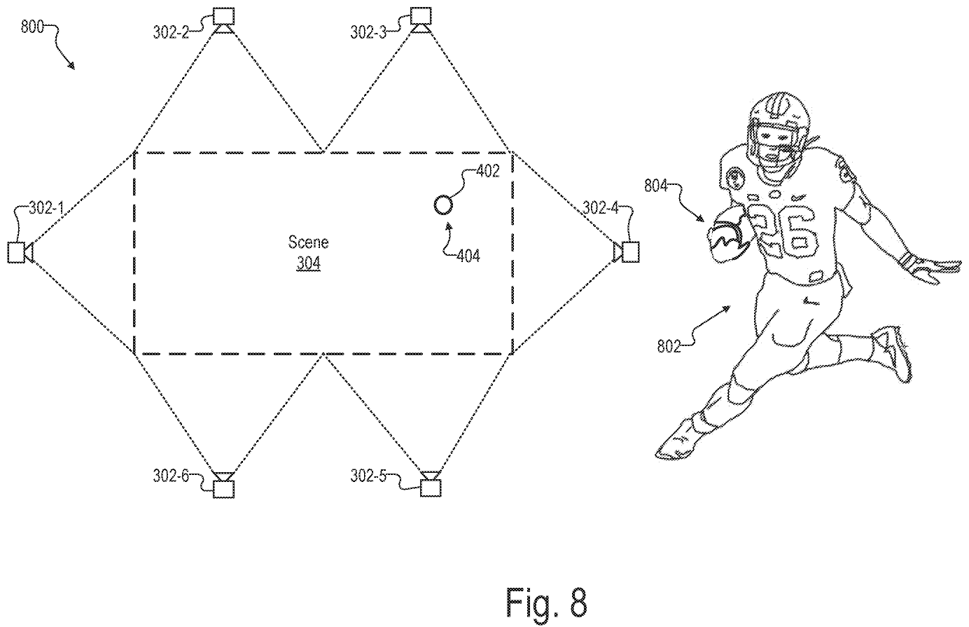

FIG. 8 shows an illustrative scenario 800 in which a deficiency in the provisional 3D representation of subject 404 may be identified at a region of the provisional 3D representation that corresponds to a region of subject 404 that: 1) is located within one or more of the different fields of view of cameras 302, and 2) is represented by the image data 306 at a level of detail less than a threshold level of detail (e.g., a level of detail that is considered insufficient or suboptimal for a particular application or use case in which system 100 is implemented). As with FIG. 6, the only object 402 depicted to be present within scene 304 in scenario 600 is subject 404. In this example, subject 404 is shown to be well within the boundaries of a capture area associated with scene 304 (i.e., the boundary indicated with a dashed line in FIG. 8) and, as such, may be squarely positioned within the fields of view of various cameras 302. For example, as shown, subject 404 happens to be located within the respective fields of view of at least cameras 302-1, 302-3, 302-4, and 302-5.

Due to this position of subject 404, as well as the arrangement and configuration of the set of cameras 302, subject 404 may be viewable from several different perspectives, but may be captured with greater point density (depth image data) and/or pixel density (color image data) from some of these perspectives than others. For example, due to the proximity of cameras 302-3 through 302-5, image data captured by these cameras may capture sufficiently detailed image data for subject 404, while due to the relatively long distance between subject 404 and camera 302-1, image data captured by this camera may be associated with a lower level of detail. Indeed, given the position of subject 404 shown in FIG. 8, sufficient detail from key perspectives (e.g., the vantage point of camera 302-1) may not be captured for certain regions of subject 404 (e.g., regions that are not well lit, important regions such as a human face where insufficient detail is likely to be noticed, etc.). Accordingly, a textured mesh representation 802 illustrated in FIG. 8 for subject 404 shows a deficiency 804 in which right hand of subject 404 that happens to be carrying a football (which is understood to be important to the game being played and of interest to a user watching a representation of the game) and that happens to be tucked into shadows of the player's body (so as to be more difficult for the camera to capture in detail anyway) appears to be recreated with a lower level of detail than the rest of the mesh representation. The distorted or low-detail hand/football of deficiency 804 will be understood to represent just one example manifestation of this type of detail-related deficiency, and other types of distortions, discolorations, lack of point or pixel density, or the like may similarly manifest as this type of deficiency. As will be described in more detail below, deficiency 804 may represent yet another type of deficiency that may be remedied or otherwise mitigated by refining a provisional 3D representation (e.g., textured mesh representation 802) in accordance with principles described herein.

Returning to FIG. 5, body model parameterization 510 may be performed to help mitigate (and, in some examples, to help identify) any of the deficiencies that have been described (e.g., deficiencies 604, 708, 804, etc.). As indicated by an arrow extending from textured mesh representation 508 to body model parameterization 510, body model parameterization 510 may be performed based on a provisional 3D representation of subject 404 such as textured mesh representation 508 or another suitable provisional 3D representation of the subject (e.g., point cloud representation 504, mesh representation 506, etc.). More specifically, system 100 may perform body model parameterization 510 by determining a set of parameters that, when applied, produces a parameterized body model that imitates a pose of the provisional 3D representation of subject 404 (e.g., the pose of textured mesh representation 508 in this example).

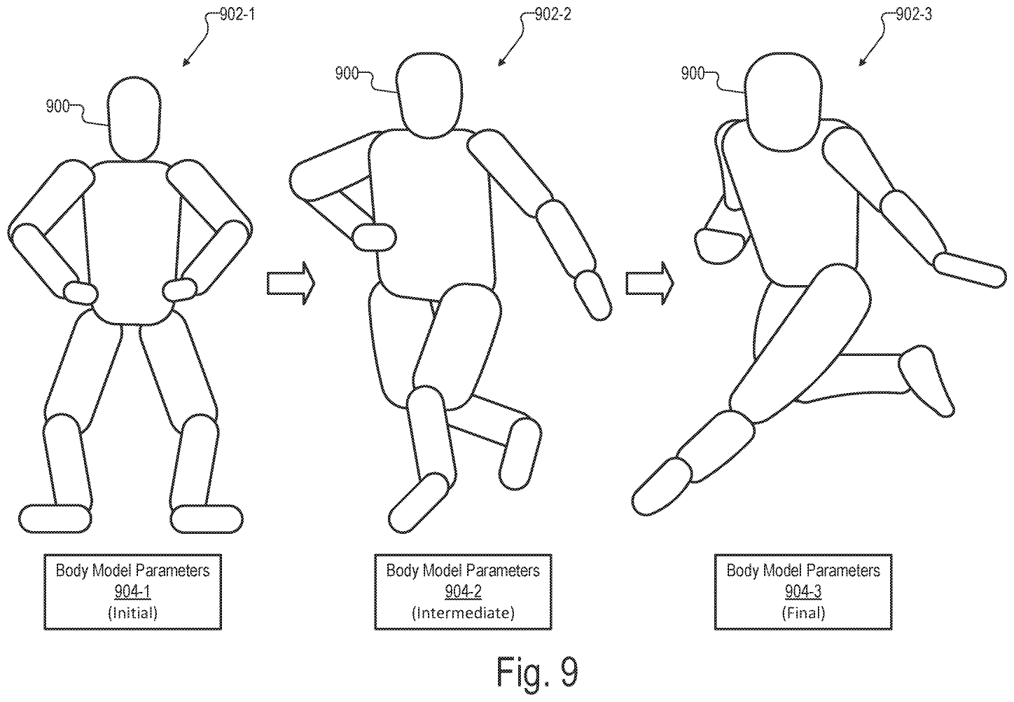

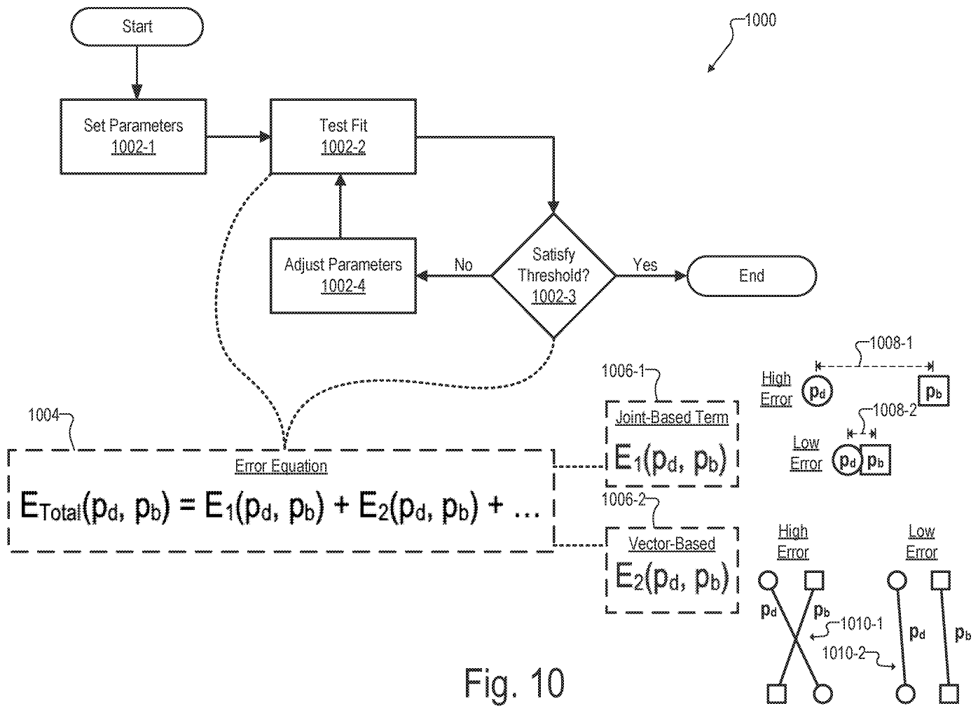

To illustrate, FIGS. 9-10 shows illustrative aspects of an example model-fitting technique that may be used by system 100 to implement body model parameterization 510 (i.e., to determine a set of parameters configured to fit a parameterizable body model to the pose of subject 404). More particularly, FIG. 9 shows an illustrative parameterizable body model in a series of poses (including a generic initial pose and a final pose imitating the pose of the provisional 3D representation of subject 404), while FIG. 10 depicts a flow diagram and an example error equation (including certain illustrative error terms and illustrations of what they may represent) that may be used by the model fitting technique.

In FIG. 9, a rough sketch of a parameterizable body model 900 is shown in three different poses 902: an initial pose 902-1, an intermediate pose 902-2, and a final pose 902-3. As indicated by respective boxes under each pose 902, each pose 902 may be defined by a corresponding set of body model parameters 904: an initial set of body model parameters 904-1 that defines initial pose 902-1, an intermediate set of body model parameters 904-2 that defines intermediate pose 902-2, and a final set of body model parameters 904-3 that defines final pose 902-3. The objective of body model parameterization 510 may be to start with some initial set of parameters defining a relatively generic pose of a relatively generic body model (e.g., a human body model in this example) and to adjust the parameters (e.g., in a series of iterative steps producing a series of intermediate poses) until the parameters define the particular physical characteristics (e.g., height, build, etc.) and specific pose of the provisional 3D representation of the subject. For example, 3D joints (e.g., body parts illustrated as different segments of parameterizable body model 900, connections between these body parts, etc.) may be detected within the various 2D images depicting the subject, and the set of body model parameters 904 may be iteratively modified in an attempt to align these detected joints with those of parameterizable body model 900.

In this way, a generic body model in a generic pose (such as illustrated by pose 902-1) may be iteratively adjusted (through intermediate poses such as pose 902-2) until reaching a final pose (pose 902-3) in which the joints of the body model imitate the corresponding joints of the subject represented in the captured image data (e.g., image data 306) and in the provisional 3D representation (e.g., any of representations 504-508). As shown by FIG. 9, this fitting of the body model may cause various characteristics of the body model to change (e.g., the subject 404 in this example happens to be taller and have a more muscular build than the generic model, though it will be understood that other subjects could be shorter and/or have a more slender build, etc.) as well as for the posture of the body model to change (e.g., the subject 404 is in a running posture rather than a generic standing posture with hands on hips like the initial body model). In some examples, the fitting performed as part of body model parameterization 510 may further include fitting hair, clothing, and/or other such features that are not explicitly shown in FIG. 9 or described within the scope of the present disclosure.

System 100 may determine the set of body model parameters 904 (e.g., parameterizing body model 900 from initial pose 902-1 until ultimately reaching final pose 902-3) in any manner as may serve a particular implementation. For instance, in certain implementations, the determining of the set of parameters 904 for body model 900 may be performed using a model-fitting technique associated with an error equation that quantifies a fit of the body model to the pose of the provisional 3D representation. Such a model-fitting technique may involve iteratively adjusting and reassessing the fit of the body model to the pose of the provisional 3D representation with an objective of minimizing the error equation until the error equation satisfies a predetermined error threshold that represents an acceptable error in the fit of the body model to the pose of the provisional 3D representation. This error equation may include a plurality of terms representing different aspects of the fit of body model 900 to the pose of the provisional 3D representation and the error equation may be configured to quantify the fit of the body model to the pose of the provisional 3D representation based on a combination of different assessments of the fit corresponding to the plurality of terms. For example, if the error equation has two terms (also referred to as loss terms or error terms), system 100 may sum the error represented by both terms after each iteration (i.e., after each intermediate adjustment of the set of body model parameters 904) with an aim to decrease the error terms to the lowest values possible (representing the best imitation of the provisional 3D representation). By having different terms in the error equation, different aspects of the fit of the body model may be independently assessed and constrained to thereby produce a highly accurate fit that accounts for all of the different aspects.

To illustrate how an error equation with different terms may be employed to iteratively perform the body model parameterization shown in FIG. 9, FIG. 10 shows a flow diagram 1000 for an illustrative model-fitting technique that may be used by system 100 to perform body model parameterization 510 in certain examples. As shown, flow diagram 1000 includes a plurality of operations 1002 (i.e., operations 1002-1 through 1002-4) that system 100 may perform in the course of performing body model parameterization 510 (e.g., by performing model fitting technique 1000).

At operation 1002-1, system 100 may begin the model-fitting technique by setting or otherwise obtaining an initial set of parameters (“Set Parameters”). The parameters set or obtained at this step may be a default set of parameters such as initial body model parameters 904-1 or may be based on parameters determined as part of a related operation (e.g., body model parameters determined for a previous frame, body model parameters that have been predetermined for the particular subject and only need to be modified to adjust the posture, etc.).

At operation 1002-2, system 100 may assess or otherwise test the body model parameters (“Test Fit”) that were initially set at operation 1002-1 or that have been adjusted by operation 1002-4 (described in more detail below). For example, at operation 1002-2, system 100 may assess the characteristics of joints, vectors, and/or other aspects of the body model (as it has been parameterized up to this point) and the provisional 3D representation of the subject (posed in the way that is targeted for imitation by the model) in accordance with an error equation 1004 that may include one or more terms 1006 (e.g., terms 1006-1 and 1006-2 in this example). As will be described in more detail below, an error equation such as error equation 1004 may allow system 100 to objectively quantify how close the fit of the body model is to the target pose of the subject so that, even if the body model never perfectly imitates the pose of the subject, system 100 may determine when the fit is close enough to be considered final (e.g., as with the final pose 902-3 illustrated in FIG. 9).

To this end, system 100 may, at operation 1002-3, determine if the fit quantified at operation 1002-2 satisfies an objective predetermined error threshold (“Satisfy Threshold?”). For example, the error threshold may have been determined ahead of time (e.g., by a designer of the system) to represent an acceptable or target error in the fit of the body model to the pose of the provisional 3D representation threshold.

As shown, if it is determined at operation 1002-3 that the error threshold is satisfied by the current set of parameters (“Yes”), flow diagram 1000 may be considered to be at an end and these parameters may be applied to produce the parameterized body model used for refining the provisional 3D representation in the ways described herein. Conversely, if it is determined at operation 1002-3 that the error threshold is not satisfied by the current set of parameters (“No”), flow diagram 1000 may continue on to operation 1002-4, where the parameters may be adjusted (“Adjust Parameters”) to attempt to make the body model better fit the target pose of the provisional 3D representation. Using this feedback loop, the model-fitting technique may loop and iterate for a maximum number of cycles or until the fit of the body model is such that the error threshold becomes satisfied and the flow diagram ends.

Error equation 1004 may be used in the ways described above to assess the fit of the body model to the target pose of the provisional 3D representation. More specifically, error equation 1004 may be used to quantify how well parameterized the body model is (how optimal the current set of body model parameters 904 are) in light of the objective to parameterize the body model to imitate the subject. To this end, as shown, error equation 1004 may be configured to quantify a total amount of error (E_{Total}) as a function of the pose detected for the subject (p_{d}) and the pose of the body model (pa) when the current set of body model parameters are applied. As mentioned above, this total error may be determined as a sum of different aspects of error quantified using different terms (E₁, E₂, etc.). Accordingly, as shown, error equation 1004 may set E_{Total}(p_{d}, p_{b}) equal to the sum of error terms E₁(p_{d}, p_{b}), E₂(p_{d}, p_{b}), and/or any other error terms as may serve a particular implementation. It will also be understood that only a single error term may be used in certain implementations.

Next to error equation 1004, FIG. 10 shows two example error terms 1006 (i.e., error terms 1006-1 and 1006-2) that may be used in certain implementations. It will be understood that these error terms are given by way of illustration only, and that additional or different error terms may be used in error equation 1004 in other examples. Additionally, while not explicitly shown in FIG. 10, it will be understood that coefficients may be assigned to various terms of error equation 1004 to thereby assign respective weights to the terms in accordance with which terms or subterms are considered to be most important. For example, if the E₁ term is considered to be of higher importance than the E₂ term for assessing the overall error in the fit, E₁ may be assigned a higher weight (e.g., a larger coefficient) than E₂. As another example, if a particular term such as E₁ is associated with a plurality of components (e.g., a plurality of joints, vectors, etc., as will be described in more detail below), subterms for each of these components may be incorporated within the E₁ term and may be similarly weighted according to their importance (e.g., the position of elbow and wrist joints may be weighted heavier than the position of joints associated with different fingers on the hand, etc.).

The first error term 1006-1 included in this implementation of error equation 1004 is a joint-based term configured to account for a position similarity between joints of the body model and corresponding joints of the subject as represented in the provisional 3D representation. To illustrate, circles labeled p_{d} will be understood to represent detected positions of one particular joint (e.g., an elbow, a shoulder, a hand, etc.) of subject 404 as represented in the provisional 3D representation, while squares labeled p_{b} will be understood to represent current positions of the corresponding joint (e.g., the elbow, shoulder, or hand, etc.) of the parameterizable body model 900 according to the current set of body model parameters being assessed or tested. As shown, a relatively large distance 1008-1 between these joints may be associated with a low position similarity (i.e., the positions of the joints are not particularly similar as they are relatively far apart) and a corresponding high degree of error (“High Error”) when the joint-based term 1006-1 is assessed. In contrast, a relatively small distance 1008-2 between these joints may be associated with a high position similarity (i.e., the positions of the joints are substantially similar as they are relatively near one another) and a corresponding low degree of error (“Low Error”) when the joint-based term 1006-1 is assessed.

The second error term 1006-2 included in this implementation of error equation 1004 is a vector-based (or bone-based) term configured to account for a pose similarity between vectors extending between particular joints of the body model and corresponding vectors extending between particular joints of the subject as represented in the provisional 3D representation. To illustrate, vectors labeled p_{d} and extending between joints represented by circles will be understood to represent detected poses of one particular vector between particular joints (e.g., a vector between a shoulder joint and an elbow joint representing the humerus bone, etc.) of subject 404 as represented in the provisional 3D representation, while vectors labeled p_{b} and extending between joints represented by squares will be understood to represent current poses of corresponding vectors between the particular joints (e.g., the vector representing the humerus bone, etc.) of the parameterizable body model 900 according to the current set of body model parameters being assessed. As shown, vectors at relatively disparate angles 1010-1 may be associated with a low pose similarity (i.e., the poses of the vectors or bones are not particularly similar as they are angled and oriented in substantially different ways) and a corresponding high degree of error (“High Error”) when the vector-based term 1006-2 is assessed. In contrast, vectors at relatively parallel angles 1010-2 may be associated with a high pose similarity (i.e., the poses of the vectors or bones are substantially similar as they are angled and oriented in the same ways) and a corresponding low degree of error (“Low Error”) when the vector-based term 1006-2 is assessed.

As mentioned above, different error terms may be useful at characterizing differing aspects of the current fit provided by a particular set of body model parameters. This is illustrated in FIG. 10 by how different the error may be for an assessment of vector-based term 1006-2 in a situation when assessment of joint-based term 1006-1 would reveal the same amount of error. Specifically, as shown, corresponding joints in the high and low error scenarios associated with vector-based term 1006-2 (i.e., the distances between the top circle and square, the distances between the bottom circle and square, etc.) are shown to be identical in both scenarios. Accordingly, if only joint-based term 1006-1 were used to assess the error of these joints, both assessments would be expected to identify the same amount of error. By assessing the respective angles 1010-1 and 1010-2 between the corresponding joints, however, FIG. 10 shows how a different assessment of the error may be achieved in this scenario (i.e., angle 1010-1 revealing the High Error and angle 1010-2 revealing the Low Error, as shown). It will be understood that various terms 1006 within error equation 1004 may be operative in complementary and cooperative manners such as this to ensure an accurate and effective assessment of different aspects of error in the model fitting being performed.

Returning to FIG. 5, once body model parameterization 510 has been completed in accordance with the principles described in relation to FIGS. 9 and 10, system 100 may proceed to perform textured mesh refinement 512 to produce the refined 3D representation 514 (e.g., another textured mesh representation that has been refined to correct, reduce, or otherwise mitigate the identified deficiencies of the provisional 3D representation of textured mesh representation 508).

As has been mentioned, one aspect of refining a provisional 3D representation is identifying the deficiencies that are to be mitigated in the refinement. This identifying of deficiencies may be performed in any suitable way, including in ways that analyze only the provisional 3D representation (e.g., to determine if there is a missing or deficient body part such as the missing hand or foot illustrated, respectively, by deficiencies 604 and 804) and/or in ways that leverage the parameterized body model produced by the parameterization 510 process. For example, as mentioned above, once the parameterized body model is completely fitted to the pose of the subject, various pixels represented in captured image data 306 for the subject may be projected to the corresponding locations on the surface of the parameterized body model (e.g., among the vertices of the body model). Each detected point associated with the provisional 3D representation may be matched with its closest vertex on the parameterized body model and, once all points are matched to their corresponding vertices, any vertices detected to not be associated with any points (or detected to be associated with a number of associated points below a set threshold) may be marked as a deficiency (e.g., an occluded region, an out-of-frame region, an insufficiently-detailed region, etc.).

Once the deficiencies have been identified in the provisional 3D representation in any of these ways (e.g., leveraging or not leveraging the parameterized body model), system 100 may perform textured mesh refinement 512 to mitigate the identified deficiencies in any suitable manner to thereby generate the refined 3D representation 514. As one example, based on an identified deficiency (e.g., a nose on the subject's face that is partially occluded or otherwise lacks sufficient detail), system 100 may define a feature area on the provisional 3D representation (e.g., an area including the nose and surrounding part of the face) and a corresponding feature area on the parameterized body model. Given these corresponding feature areas, system 100 may identify base points in the feature area of the provisional 3D representation and map these to corresponding base points of the body model. System 100 may then deform the provisional 3D representation (e.g., raising or lowering points within the feature area) in accordance with corresponding points of the body model. For example, these target points may be raised or lowered along a specified vector (e.g., orthogonal to the main surface of the body model in the area) until they intersect with the parameterized body model. In the example of the nose, these base points could include the facial areas surrounding the nose (which are used for the alignment), then the feature points in the target mesh (representing the nose itself) may be moved along a vector orthogonal to the face until they intersect the corresponding body model mesh. In some examples, the textured mesh refinement 512 may involve interpolating surface points from captured data to initially fill deficient parts of the 3D representation.

In some implementations, upsampling may be performed to attempt to create a uniform distribution of points and/or vertices in the deficient area as compared to other areas of the 3D representation being refined. For example, since it may not be possible to deform a single triangle (or small number of triangles) that may currently be associated with the provisional 3D representation of the nose to imitate the nuances of the nose represented by the body model, system 100 may artificially generate additional triangles (by upsampling to create data that was not actually captured) that may be deformed to more closely match the body model mesh and/or to approximately match the vertex density that is desired (e.g., the vertex density present on other parts of the 3D representation). In these ways, insights obtained from the parameterized body model about how subject 404 is expected to look may be imported into refined 3D representation 514 to fill holes and otherwise mitigate identified deficiencies of the provisional 3D representation based on the captured data alone.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory. Common forms of computer-readable media include, for example, a disk, hard disk, magnetic tape, any other magnetic medium, a compact disc read-only memory (CD-ROM), a digital video disc (DVD), any other optical medium, random access memory (RAM), programmable read-only memory (PROM), electrically erasable programmable read-only memory (EPROM), FLASH-EEPROM, any other memory chip or cartridge, or any other tangible medium from which a computer can read.

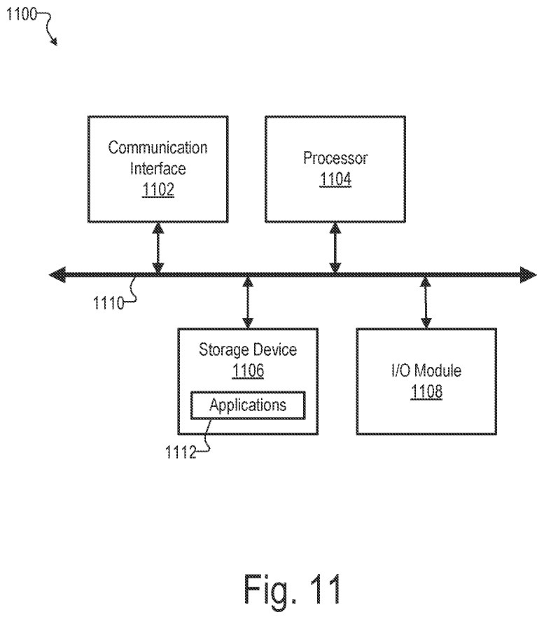

FIG. 11 shows an illustrative computing device 1100 that may implement certain of the volumetric modeling systems and/or other computing systems and devices described herein. For example, computing device 1100 may include or implement (or partially implement) a volumetric modeling system such as system 100, one or more cameras such as any of cameras 302 described herein, an XR presentation device such as XR presentation device 312, certain elements of a network such as network 310, and/or any other computing devices or systems described herein (or any elements or subsystems thereof).

As shown in FIG. 11, computing device 1100 may include a communication interface 1102, a processor 1104, a storage device 1106, and an input/output (I/O) module 1108 communicatively connected via a communication infrastructure 1110. While an illustrative computing device 1100 is shown in FIG. 11, the components illustrated in FIG. 11 are not intended to be limiting. Additional or alternative components may be used in other embodiments. Components of computing device 1100 shown in FIG. 11 will now be described in additional detail.

Communication interface 1102 may be configured to communicate with one or more computing devices. Examples of communication interface 1102 include, without limitation, a wired network interface (such as a network interface card), a wireless network interface (such as a wireless network interface card), a modem, an audio/video connection, and any other suitable interface.

Processor 1104 generally represents any type or form of processing unit capable of processing data or interpreting, executing, and/or directing execution of one or more of the instructions, processes, and/or operations described herein. Processor 1104 may direct execution of operations in accordance with one or more applications 1112 or other computer-executable instructions such as may be stored in storage device 1106 or another computer-readable medium.

Storage device 1106 may include one or more data storage media, devices, or configurations and may employ any type, form, and combination of data storage media and/or device. For example, storage device 1106 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 1106. For example, data representative of one or more executable applications 1112 configured to direct processor 1104 to perform any of the operations described herein may be stored within storage device 1106. In some examples, data may be arranged in one or more databases residing within storage device 1106.

I/O module 1108 may include one or more I/O modules configured to receive user input and provide user output. One or more I/O modules may be used to receive input for a single virtual experience. I/O module 1108 may include any hardware, firmware, software, or combination thereof supportive of input and output capabilities. For example, I/O module 1108 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1108 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 1100. For example, one or more applications 1112 residing within storage device 1106 may be configured to direct processor 1104 to perform one or more processes or functions associated with processor 104 of system 100. Likewise, memory 102 of system 100 may be implemented by or within storage device 1106.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

In the preceding description, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
obtaining, by a volumetric modeling system, a provisional 3D representation of a subject present at a scene, the provisional 3D representation based on image data captured by a set of cameras configured to have different fields of view according to different vantage points the cameras have at the scene;
identifying, by the volumetric modeling system, a deficiency in the provisional 3D representation of the subject;
determining, by the volumetric modeling system, a set of parameters for a body model that is parameterizable to adaptively model a body type of the subject, the determining performed such that an application of the set of parameters to the body model produces a parameterized body model that imitates a pose of the provisional 3D representation of the subject; and
generating, by the volumetric modeling system and based on the provisional 3D representation and the parameterized body model, a refined 3D representation of the subject in which the deficiency is mitigated.

2. The method of claim 1, wherein:
the subject is a human subject present at the scene;
the provisional 3D representation is a point cloud representation of the human subject; and
the refined 3D representation is a textured mesh representation of the human subject.

3. The method of claim 1, wherein the deficiency in the provisional 3D representation of the subject is identified at a region of the provisional 3D representation that corresponds to a region of the subject that is not located within any of the different fields of view of the set of cameras.

4. The method of claim 1, wherein the deficiency in the provisional 3D representation of the subject is identified at a region of the provisional 3D representation that corresponds to a region of the subject that is occluded, within a particular one of the different fields of view in which the region of the subject is located, by an object present at the scene and further located in the particular one of the different fields of view.

5. The method of claim 1, wherein the deficiency in the provisional 3D representation of the subject is identified at a region of the provisional 3D representation that corresponds to a region of the subject that:
is located within one or more of the different fields of view, and
is represented by the image data at a level of detail less than a threshold level of detail.

6. The method of claim 1, wherein:
the determining of the set of parameters for the body model is performed using a model-fitting technique associated with an error equation that quantifies a fit of the body model to the pose of the provisional 3D representation; and
the model-fitting technique involves iteratively adjusting and reassessing the fit of the body model to the pose of the provisional 3D representation with an objective of minimizing the error equation until the error equation satisfies a predetermined error threshold that represents an acceptable error in the fit of the body model to the pose of the provisional 3D representation.

7. The method of claim 6, wherein:
the error equation includes a plurality of terms representing different aspects of the fit of the body model to the pose of the provisional 3D representation; and
the error equation is configured to quantify the fit of the body model to the pose of the provisional 3D representation based on a combination of different assessments of the fit corresponding to the plurality of terms.

8. The method of claim 6, wherein the error equation includes a joint-based term configured to account for a position similarity between joints of the body model and corresponding joints of the subject as represented in the provisional 3D representation.

9. The method of claim 6, wherein the error equation includes a vector-based term configured to account for a pose similarity between vectors extending between particular joints of the body model and corresponding vectors extending between particular joints of the subject as represented in the provisional 3D representation.

10. The method of claim 1, wherein:
the determining of the set of parameters for the body model is performed prior to the identifying of the deficiency in the provisional 3D representation of the subject;
the method further comprises applying, by the volumetric modeling system subsequent to the application of the set of parameters to the body model, texture content to the parameterized body model, the texture content based on the image data captured by the set of cameras; and
the identifying of the deficiency in the provisional 3D representation is performed based on an analysis of the parameterized body model to which the texture content has been applied.

11. The method of claim 1, wherein:
the image data captured by the set of cameras includes both color data and depth data representative of objects present at the scene; and
the obtaining of the provisional 3D representation of the subject is performed by generating the provisional 3D representation of the subject based on color data and depth data representative of the subject.

12. The method of claim 1, further comprising providing, by the volumetric modeling system, the refined 3D representation of the subject to an extended reality (XR) presentation device that is configured to provide an extended reality experience to a user and to present the refined 3D representation to the user as part of the extended reality experience.

13. A system comprising:
a memory storing instructions; and
one or more processors communicatively coupled to the memory and configured to execute the instructions to perform a process comprising:
obtaining a provisional 3D representation of a subject present at a scene, the provisional 3D representation based on image data captured by a set of cameras configured to have different fields of view according to different vantage points the cameras have at the scene;
identifying a deficiency in the provisional 3D representation of the subject;
determining a set of parameters for a body model that is parameterizable to adaptively model a body type of the subject, the determining performed such that an application of the set of parameters to the body model produces a parameterized body model that imitates a pose of the provisional 3D representation of the subject; and
generating, based on the provisional 3D representation and the parameterized body model, a refined 3D representation of the subject in which the deficiency is mitigated.

14. The system of claim 13, wherein:
the subject is a human subject present at the scene;
the provisional 3D representation is a point cloud representation of the human subject; and
the refined 3D representation is a textured mesh representation of the human subject.

15. The system of claim 13, wherein the deficiency in the provisional 3D representation of the subject is identified at a region of the provisional 3D representation that corresponds to a region of the subject that is not located within any of the different fields of view of the set of cameras.

16. The system of claim 13, wherein the deficiency in the provisional 3D representation of the subject is identified at a region of the provisional 3D representation that corresponds to a region of the subject that is occluded, within a particular one of the different fields of view in which the region of the subject is located, by an object present at the scene and further located in the particular one of the different fields of view.

17. The system of claim 13, wherein the deficiency in the provisional 3D representation of the subject is identified at a region of the provisional 3D representation that corresponds to a region of the subject that:
is located within one or more of the different fields of view, and
is represented by the image data at a level of detail less than a threshold level of detail.

18. The system of claim 13, wherein:
the determining of the set of parameters for the body model is performed using a model-fitting technique associated with an error equation that quantifies a fit of the body model to the pose of the provisional 3D representation;
the model-fitting technique involves iteratively adjusting and reassessing the fit of the body model to the pose of the provisional 3D representation with an objective of minimizing the error equation until the error equation satisfies a predetermined error threshold that represents an acceptable error in the fit of the body model to the pose of the provisional 3D representation;
the error equation includes a plurality of terms representing different aspects of the fit of the body model to the pose of the provisional 3D representation; and
the error equation is configured to quantify the fit of the body model to the pose of the provisional 3D representation based on a combination of different assessments of the fit corresponding to the plurality of terms.

19. The system of claim 13, wherein:
the determining of the set of parameters for the body model is performed prior to the identifying of the deficiency in the provisional 3D representation of the subject;
the process further comprises applying, subsequent to the application of the set of parameters to the body model, texture content to the parameterized body model, the texture content based on the image data captured by the set of cameras; and
the identifying of the deficiency in the provisional 3D representation is performed based on an analysis of the parameterized body model to which the texture content has been applied.

20. A non-transitory computer-readable medium storing instructions that, when executed, direct a processor of a computing device to perform a process comprising:
obtaining a provisional 3D representation of a subject present at a scene, the provisional 3D representation based on image data captured by a set of cameras configured to have different fields of view according to different vantage points the cameras have at the scene;
identifying a deficiency in the provisional 3D representation of the subject;
determining a set of parameters for a body model that is parameterizable to adaptively model a body type of the subject, the determining performed such that an application of the set of parameters to the body model produces a parameterized body model that imitates a pose of the provisional 3D representation of the subject; and
generating, based on the provisional 3D representation and the parameterized body model, a refined 3D representation of the subject in which the deficiency is mitigated.
